(19) United States
(12) Patent Application Publication
(10) Pub. No.: US 2010/0323112 A1
(43) Pub. Date: Dec. 23, 2010

(54) METHOD FOR IMPROVING SAG RESISTANCE

(75) Inventors: Arne Rick, Commerce Township, MI (US); David J. Law, Livonia, MI (US)

Correspondence Address: Harness, Dickey and Pierce, P.L.C., 5445 Corporate Drive, Troy, MI, 48098, US

(73) Assignee: BASF CORPORATION, Wyandotte, MI (US)

(21) Appl. No.: 12/487,445

(22) Filed: Jun. 18, 2009

(51) Int. Cl. C08G 73/10; B05D 3/10

(52) U.S. Cl. 427/387; 524/879

(57) ABSTRACT

A coating composition made with fumed silica, a hydroxy-functional amide compound, and a volatile organic portion, wherein the volatile organic portion comprises about 1 to about 7% by weight of a first volatile organic liquid or combination of first volatile organic liquids (i) having an evaporation rate less than or equal to 0.1 and (ii) in which the hydroxy-functional amide compound is insoluble has improved sag resistance. Sag resistance may be further improved by including in the volatile organic portion at least about 10% by weight of a second volatile organic liquid having an evaporation rate greater than or equal to about 2.0. Finally, flow and leveling of the coating (resulting in reduced orange peel and smoother appearance) can be improved, without worsening sag resistance, by including from about 5% to about 60% by weight of a dispersant for the fumed silica based on weight of fumed silica, wherein the dispersant is soluble in the first volatile organic liquid or liquids.

### FIELD

This disclosure concerns coating compositions containing fumed silica and organic solvents, especially curable (thermosetting) automotive topcoat coating compositions.

### BACKGROUND

This section provides background information related to the present disclosure that may or may not be prior art.

Solventborne coating compositions, especially thermoset (curable) coating compositions, are widely used in the coatings art. They are often used as topcoats in the automotive and industrial coatings industry, monocoat topcoat compositions that produce glossy color coatings or as basecoat or clearcoat coating compositions for forming color-plus-clear composite coatings where exceptional gloss, depth of color, distinctness of image, or special metallic effects are desired.

Topcoat coatings require an extremely high degree of surface smoothness to achieve a high distinctness of image (DOI). Clearcoat and monocoat topcoat coating layers are generally relatively thick, typically between 1.5 and 3 mils (about 38 to about 76 microns) thick for both appearance and protection. In coating automotive vehicle bodies, the topcoat is applied to both horizontal and vertical surfaces. Manufacturing economy constraints require this relatively thick clearcoat or monocoat topcoat layer be applied in a minimum of time and manufacturing floor space; accordingly, the clearcoat or monocoat coating composition is applied thickly onto the substrate, leaving in the coating layer a significant amount of solvent that must be evaporated before bake, during a “flash” period of solvent evaporation, and during bake of the topcoat. While there is less of a problem on horizontal surfaces with applying a rather thick coating layer leaving significant solvent content in the layer, on vertical surfaces a topcoat layer with still significant solvent content may flow too much, causing sags to develop in the coating layer. Sagging may also occur in other areas where the substrate is not flat horizontally, for example along character lines, gutters, or channels of an automotive vehicle body.

Different methods have been proposed for preventing sagging while allowing enough flow for leveling and smoothing of the film before curing. For example, various rheology control additives (generally thixotropes) have been used so that a substantial increase in viscosity is attained when a portion of the solvent evaporates during spray application. One thixotrope that has been added to solventborne coating compositions, including topcoat compositions, is hydrophobically-modified fumed silica. The amount of fumed silica that can be incorporated is often limited, however, as higher levels of fumed silica in the coating composition can cause a marked decrease in coating gloss, a particularly undesirable effect in a clearcoat coating and result in filtering problems in the coating system.

Thixotropes may be used in other coating compositions as well, including primer compositions and basecoat compositions containing special effect flake pigments. Special effect pigments are those that can produce a gonioapparent effect in a coating layer. For example, the American Society of Testing Methods (ASTM) document F284 defines metallic as “pertaining to the appearance of a gonioapparent material containing metal flake.” Metallic basecoat colors may be produced using metallic flake pigments like aluminum flake pigments including colored aluminum flake pigment, copper flake pigments, zinc flake pigments, stainless steel flake pigments, and bronze flake pigments and/or using pearlescent flake pigments including treated micas like titanium dioxide-coated mica pigments and iron oxide-coated mica pigments to give the coatings a different appearance when viewed at different angles. Rheology control is needed during application of these coating compositions to allow the flakes to orient parallel to the face of the film for optimum gonioapparent effect. While primers and basecoats are not outermost layers of a coating system, it is known that surface irregularities in these layers, including orange peel, can telegraph though to cause a less than mirror smooth surface for the clearcoat or monocoat layer lying above.

Haubennestel et al., U.S. Pat. No. 4,857,111 describes addition of a hydroxyl containing amide of a dicarboxylic acid or tricarboxylic acid to a composition with highly disperse (fumed) silica to enhance the effect of the silica. The hydroxyl containing amide is prepared by reacting the carboxylic acid compound (which may have amide or ether groups) or esterifiable ester or anhydride of such a compound with an aminoalcohol. The hydroxyl group may be esterified (e.g., with a lactone or glycidol) or etherified (e.g., with ethylene oxide). The Haubennestel '111 patent warns that concentration effects utility and the optimum concentration will differ from formulation to formulation depending on, for example, the polarity and nature of the resins and solvents present, and the like. The Haubennestel '111 compositions contain solvents that are aliphatic, aromatic, and moderately polar solvents; the hydroxyl containing amide compounds may be dissolved in solvents such as esters or ketone in high solids coating compositions. Reichert et al. U.S. Pat. No. 5,349,011 discloses a polyamide ester (oligomeric amide ester) may be used as a rheological additive in an organic solvent-based composition. The Reichert polyamide ester rheological additive is said to be a substantial improvement over particulate-type rheological additives exemplified by fumed silica. The polyamide ester is dissolved in an organic solvent and is said to work by an associative interaction with pigment. The polyamide ester is said to be most effective used in a solvent containing 50% by weight alcohol.

Haubennestel et al., U.S. Pat. No. 6,596,816 describes pigment dispersants based on amidated acrylic polymers with weight average molecular weight of 1000-50,000. A polymer of acrylic acid esters is amidifed with a diamine have one tertiary amine group and transesterified with a long chain alcohol. The pigment dispersant is used in amounts of 0.5 to 100 parts by weight based on 100 parts by weight of the pigment to be dispersed; the dispersion may be aqueous or in organic solvent. Haubennestel et al., U.S. Pat. No. 4,942,213 describes pigment dispersants prepared by reacting a polyisocyanates, such as an isocyanurate, with a monoalcohols and/or monoamines, one of which contains a nitrogen-containing basic group.

### SUMMARY

We disclose a curable coating composition containing (a) fumed silica; (b) a hydroxy-functional amide compound of formula I

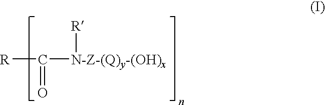

wherein R is selected from aliphatic hydrocarbon groups having 2 to 60 carbon atoms, aromatic hydrocarbon groups having 6 to 20 carbon atoms, and aliphatic and aliphatic/aromatic radicals having 6 to 150 carbon atom interrupted by up to 8 amide groups, ester groups, a combination of amide and ester groups, or optionally any of these and also with interrupting amine groups, and aliphatic radicals having 4 to 150 carbon atoms interrupted by 2 to 75 oxygen atoms or ester groups; R′ is H, an alkyl group with one to four carbon atoms, or -Z′-(Q)_{y}-(OH)ₓ; x is 1, 2, or 3; y is 0 or 1; Z and Z′ are independently alkylene radicals having 2 to 6 carbon atoms; Q is an aliphatic hydrocarbon radical having 2 to 200 carbon atoms that is linked to Z or Z′ by an ether or carboxylic acid ester group and is interrupted by 0 to 99 oxygen atoms and/or carboxylic acid ester groups; and n is 2 or 3; and (c) a volatile organic portion, wherein the volatile organic portion comprises about 1 to about 7% by weight of a first volatile organic liquid or combination of first volatile organic liquids (i) having an evaporation rate less than or equal to 0.1 and (ii) in which the hydroxy-functional amide compound is insoluble. “Insoluble” mean that a 10% by weight of a solution of the hydroxy-functional amide compound of formula I (50% by weight in xylene/alkylbenzenes/isobutanol in a 5/4/1 weight ratio) is insoluble or marginally soluble at 20° C. in the first volatile organic liquid or liquids, as evidenced by visible turbidity or separation into layers, or that 5% by weight of the hydroxy-functional amide compound of formula I itself is insoluble or marginally soluble at 20° C. in the first volatile organic liquid or liquids, as evidenced by visible turbidity or separation into layers. In this disclosure we will use “insoluble” in this way to encompass both insoluble and marginally soluble according to this test. The hydroxy-functional amide compound is soluble in one or more volatile organic liquids other than the first liquid or liquids of the volatile organic portion, so that, overall, it is soluble in the volatile organic portion.

We also disclose a method of spray applying the curable coating composition in a layer on a substrate, then curing the applied coating composition to produce a cured coating on the substrate. Including the volatile organic portion comprising about 1 to about 7% by weight of the first volatile organic liquid or liquids in the fumed silica-containing coating composition unexpectedly and significantly improves sag resistance of the coating during spray application and curing. In various embodiments, the curable coating composition is a primer coating composition, a basecoat coating composition, a monocoat coating composition, or a clearcoat coating composition. In various embodiments, the curable coating composition is applied to a substrate in a vertical surface of the substrate or area of a horizontal surface that is not flat. In various embodiment, the cured coating on the substrate has a film thickness between 1.5 and about 3 mils (about 31 to about 62 microns).

In various embodiments the volatile organic portion also comprises at least about 10% by weight of a second volatile organic liquid or combination of second organic liquids having an evaporation rate greater than or equal to about 2.0. During spray application of the coating composition the second volatile solvent or solvents are quickly evaporated, leaving a volatile organic portion in the applied coating layer with a relatively higher concentration of the first volatile organic liquid or liquids. At this point, or as further solubilizing volatile organic liquids evaporate from the applied coating layer, the hydroxy-functional amide compound becomes less soluble and eventually becomes insoluble in the remaining portion of volatile organic liquids as the fraction of the first volatile organic liquid or liquids increases. While not wishing to be bound by theory, we believe that this loss of solubility is responsible for the improved sag resistance of our coating compositions, which was surprising because the expected result from adding a very slow evaporating volatile organic liquid is increased sagging, or sagging at a lower filmbuild, while in our coating composition just the opposite occurs with the first volatile organic liquid or liquids as compared to the same coating composition made without such a first volatile organic liquid or liquids.

In various embodiments, the curable coating composition includes from about 1% to about 100% by weight of the hydroxy-functional amide compound based on weight of fumed silica. Among these are embodiments in which the curable coating composition includes from about 5% to about 60% by weight of the hydroxy-functional amide compound based on weight of fumed silica.

In various embodiments, the curable coating composition further includes 5 to 60% by weight of a dispersant for the fumed silica based on weight of fumed silica, wherein the pigment dispersant is soluble in the first volatile organic liquid or liquids. The first volatile organic liquid or liquids in which the hydroxy-functional amide compound is insoluble but in which the pigment dispersant is soluble not only provides the unexpected improvement in sag resistance of the coating during spray application and curing, but also unexpectedly and significantly improves leveling on horizontal surfaces at equivalent sag resistance for coating compositions without the pigment dispersant.

“Evaporation rate” refers to evaporation rate as measured by ASTM D 3539-87 (reapproved 2004), which expresses evaporation rate relative to n-butyl acetate (i.e., on a scale where the evaporation rate of n-butyl acetate=1). A “volatile” organic liquid is one that is measured as a part of the volatile organic content using ASTM D3960. A volatile organic liquid evaporates before or during curing of the coating layer and is not present after the coating layer is cured. “Aliphatic” encompasses cycloaliphatic. “A” and “an” as used herein indicate “at least one” of the item is present; a plurality of such items may be present, when possible. Other than in the working examples provides at the end of the detailed description, all numerical values of parameters (e.g., of quantities or conditions) in this specification, including the appended claims, are to be understood as being modified in all instances by the term “about.” “About” when applied to values indicates that the calculation or the measurement allows some slight imprecision in the value (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring such parameters. In addition, disclosure of ranges includes disclosure of all values and further divided ranges within the entire range. The “volatile organic liquid” may also be referred to in this description as an “organic solvent,” a term commonly used in the coatings art for the volatile organic liquids that carry the coating “binder” (film-forming materials) in the coating composition. When used in this way, “organic solvent” only implies that the binder materials are soluble in the volatile organic portion and does not imply that the hydroxy-functional amide of formula (I) or any other additive is soluble in any specific organic solvent of the volatile organic portion.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

The coating compositions have a volatile organic liquid portion, commonly referred to as “solventborne” coating compositions. The solventborne coating composition contain fumed silica. The thixotropic effectiveness of the fumed silica in the coating compositions is enhanced by including the hydroxy-functional amide compound of formula (I). The thixotropic effectiveness of the fumed silica and hydroxy-functional amide combination is further enhanced by including a first volatile organic liquid in which the hydroxyl-functional amide is not soluble, the organic liquid having an evaporation rate less than 0.1.

The Fumed Silica

The fumed silica, also known as pyrogenic silica, is a form of silicon dioxide made by flame pyrolysis of silicon tetrachloride or from quartz sand vaporized in a 3000° C. electric arc. Particle sizes of fumed silica tend to be from about 5 to 50 nm. Fumed silica is available commercially (e.g., from Cabot Corp. and Degussa AG) as both untreated and hydrophobically treated fumed silica products. Hydrophobically modified fumed silicas are generally more compatible in curable solventborne coating compositions. In various embodiments, the coating composition may include from about 0.1 to about 5 percent by weight fumed silica based on binder (the nonvolatile, film-forming components of the coating composition).

The fumed silica may be dispersed in the coating composition coating by adding a pre-made dispersion of the fumed silica which may or may not already contain the hydroxy-functional amide compound and/or pigment dispersing/wetting additives. If the premade dispersion does not already include the hydroxy-functional amide compound and/or pigment dispersing/wetting additives, these additives may be added to the fumed silica dispersion before the fumed silica dispersion is incorporated into the coating composition, or these additives may be added to the coating composition before or after the fumed silica dispersion is incorporated into the coating composition.

The Hydroxy-Functional Amide Compound

The coating composition also includes a hydroxy-functional amide compound of formula I

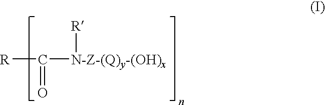

wherein R is selected from aliphatic hydrocarbon groups having 2 to 60 carbon atoms, aromatic hydrocarbon groups having 6 to 20 carbon atoms, and aliphatic and aliphatic/aromatic radicals having 6 to 150 carbon atom interrupted by up to 8 amide groups, ester groups, a combination of amide and ester groups, or optionally any of these and also with interrupting amine groups, and aliphatic radicals having 4 to 150 carbon atoms interrupted by 2 to 75 oxygen atoms or ester groups; R′ is H, an alkyl group with one to four carbon atoms, or -Z′-(Q)_{y}-(OH)ₓ; x is 1, 2, or 3; y is 0 or 1; Z and Z′ are independently alkylene radicals having 2 to 6 carbon atoms; Q is an aliphatic hydrocarbon radical having 2 to 200 carbon atoms that is linked to Z or Z′ by an ether or carboxylic acid ester group and is interrupted by 0 to 99 oxygen atoms and/or carboxylic acid ester groups; and n is 2 or 3.

In various embodiments, Q may be an aliphatic hydrocarbon group having 2 to 80 carbon atoms, which is linked via an ether oxygen or an ester group to Z or Z′ and is interrupted by zero to 39 groups individually selected from the group consisting of oxygen atoms and carboxylic acid ester groups. In various embodiments, R may be an aliphatic hydrocarbon group having 6 to 44 carbon atoms; among these are embodiments in which R is an aliphatic hydrocarbon group having 34 to 42 carbon atoms. As examples of these, R may be or include the hydrocarbon group of dodecanedioic acid or of a dimer fatty acid. Among other examples of R which may be specifically mentioned are an R that is an aliphatic hydrocarbon group having 6 to 26 carbon atoms interrupted by 3 to 13 oxygen atoms, an R that is an aliphatic hydrocarbon group having 70 to 90 carbon atoms interrupted by 2 amide groups, amine groups, ester groups, or a combination of any plurality of these,

Suitable polycarboxylic acids which can be used include those compounds which contain at least 2 carboxyl groups on a common aliphatic or aromatic hydrocarbon radical which may be interrupted by amide groups, ester groups, or —O— (ether oxygen) groups. Correspondingly, the derivatives of these carboxylic acids can also be used which are suitable for forming amide groups by reaction with primary or secondary amines. Examples of such derivatives are carboxylic acid esters, carboxylic acid halides or carboxylic acid anhydrides. Nonlimiting examples of suitable polycarboxylic acids or their derivatives used can be, for example, succinic acid, succinic anhydride, alkenylsuccinic anhydride such as, for example, 2-dodecen-1-ylsuccinic anhydride, glutaric acid, adipic acid, pimelic acid, suberic acid, azelaic acid, sebacic acid, decanedicarboxylic acid, dimerized fatty acids, trimerized fatty acids, 1,4-cyclohexanedicarboxylic acid, 1,2-cyclohexanedicarboxylic acid, 1,2-cyclohexanedicarboxylic acid anhydride, tetrahydrophthalic acid, phthalic acid, phthalic anhydride, isophthalic acid, terephthalic acid, trimellitic acid, 3,6,9-trioxaundecanedioic acid, polyglycoldioic acid (.alpha.-carboxymethyl-ω-carboxymethoxypolyoxyethylene) or mixtures of these acids.

Dimerized fatty acids (dimer fatty acids) are prepared by known processes, for example see German Offenlegungsschrift DE-OS 1,443,938; German Offenlegungsschrift DE-OS 1,443,968; German Patent DE-PS 2,118,702 and German Patent DE-PS 1,280,852. These dimerized fatty acids are polymerized unsaturated natural or synthetic aliphatic acids having 12 to 22 carbon atoms, preferably 18 carbon atoms (tall oil). The technical products contain, in addition to the dimerized acids, small quantities (e.g. about 0.1 to 3%) of the monomeric acids employed and trimeric acids. The trimeric acids can also be present in greater amounts, since these likewise yield highly effective products. It is therefore possible to employ technical products which contain up to about 30% trimeric acids. The dimerized fatty acids can also be hydrogenated. In various embodiments a dimerized fatty acid or dodecanedioic acid is used.

R may contain amide groups, particularly 2, 4, 6, or 8 amide groups, which may be formed by extension of a polycarboxylic acid that is a dicarboxylic acid or its amidifiable derivative with a diamine having two amine groups that are primary or secondary amine groups. R may optionally include interrupting amine groups, which may be introduced by diamines having tertiary amine groups between the primary and/or secondary amine groups. The diamines used for extending the chain of the polycarboxylic acids to give polycarboxylic acid polyamides can be selected from aliphatic and cycloaliphatic diamines such as, for example, ethylene diamine, 1,2-propylenediamine, 1,3-diaminopropane, 1,4-butanediamine, neopentanediamine, 4,4-diaminodicyclohexylmethane, 3-aminomethyl-3,5,5-trimethylcyclohexylamine (isophoronediamine), hexamethylenediamine, 1,12-dodecanediamine, piperazine, diethylenetriamine, triethylenetetramine, tetraethylenepentamine, pentaethylenehexamine, tripropylenetetramine, tetrapropylenepentamine, pentapropylenehexamine, or mixtures of such diamines. Aliphatic diamines having 2 to 6 carbon atoms are readily accessible and available commercially. In one embodiment, R is an aliphatic hydrocarbon radical having 70 to 90 carbon atoms interrupted by two amide groups, which may be the radical of two molecules of dimer fatty acid linked to one another by amidification with a molecule of a diamine. In various embodiment, the diamine is piperazine, diethylenetriamine, triethylenetetraamine, hexamethylenediamine, 1,12-dodecanediamine, or any combination of these.

If the chain of the polyearboxylic acid is to be extended by reaction with diamines with amide formation, this reaction is preferably carried out initially in such a way that, on the basis of the molar quantity ratios of polycarboxylic acids and diamine used, on average at least two carboxyl groups in a resulting diamide remain unconverted and are available for reaction with alkanolamines. The reaction can optionally be carried out in one step, using the appropriate molar quantities of diamine and alkanolamine relative to the polycarboxylic acid.

R may contain ester groups, particularly 2, 4, 6, or 8 ester groups, which may be formed by extension of a polycarboxylic acid that is a dicarboxylic acid or its esterifiable derivative with a diol having two hydroxyl groups. R may optionally include interrupting amine groups, which may be introduced by diols having tertiary amine groups between the hydroxyl groups. The diol used for extending the chain of the polycarboxylic acids to give polycarboxylic acid polyesters can be selected from aliphatic and cycloaliphatic diols, optionally containing heteroatoms, such as, for example, ethylene glycol, 1,2-propyleneglycol, 1,3-hydroxypropane, 1,4-butanediol, neopentyl glycol, 1,2- or 1,4-cyclohexanedimethanol, hexanediol, 1,12-dodecanediol, 1,4-bis(2-hydroxyethyl)piperazine, or mixtures of such diols. In one embodiment, R is an aliphatic hydrocarbon radical having 70 to 90 carbon atoms interrupted by two ester groups, which may be the radical of two molecules of dimer fatty acid linked to one another by esterification with a molecule of a diol. In one embodiment, the diol is 1,4-bis(2-hydroxyethyl)piperazine.

If the chain of the polycarboxylic acid is to be extended by esterification with diols, this reaction is preferably carried out initially in such a way that, on the basis of the molar quantity ratios of polycarboxylic acids and diol used, on average at least two carboxyl groups in a resulting diester remain unconverted and are available for reaction with alkanolamines.

R may contain a combination of ester groups and amide groups, and the diamines and diols, such as any of those already mentioned as suitable examples, may be used in any combination in reaction with the dicarboxylic acid to make a dicarboxylic acid extended by both esterification and amidification. Among the embodiments that may be mentioned are dimer fatty acids and/or dodecandioic acid reacted with one or more of piperazine, diethylenetriamine, triethylenetetraamine, hexamethylenediamine, 1,12-dodecanediamine in combination with 1,4-bis(2-hydroxyethyl)piperazine.

Nonlimiting examples of suitable amino alcohols that can be used for the reaction of the polycarboxylic acids to give alkanolamides are ethanolamine, diisopropanolamine, aminoethylpropanediol, diethanolamine, 2-amino-1-propanol, 3-amino-2,2-dimethyl-1-propanol, 2cyclohexylamino ethanol, 2-methylaminoethanol, 2-(2-aminoethoxy)ethanol, 2-amino-1-butanol, 2-amino-2-methyl-1-propanol, 2-amino-2-ethyl-1,3-propanediol and tris(hydroxymethyl)aminomethane. Referring again to structure I, Z preferably is an alkylene radical having 2 or 3 carbon atoms. Alkanolamines having two hydroxyl groups are used in certain embodiments, and for example R′ may represent -Z-(Q)_{y}-(OH)ₓ. In one embodiment, diethanolamine is used.

The compounds containing carboxyl groups and the alkanolamines are reacted with one another in a molar ratio of carboxyl groups to amino groups of from 1:0.5 to 1:10, preferably from 1:0.5 to 1:3 and particularly preferably from 1:0.9 to 1:1.3. The known processes for the amidation of carboxyl groups or derivatives thereof are used for the reaction.

As is known to those skilled in the art, in the reaction of alkanolamines with carboxylic acids or derivatives thereof, certain proportions of the esters can be formed in addition to the amides which are to be formed preferentially. The requirement of alkanolamide formation can, however, be regarded as met if at least 50% of the desired amide bonds have been formed and the remainder is in the form of a carboxylic acid ester or byproduct. According to the state of the art, all the reactions can be carried out either in bulk or in the presence of suitable solvents which do not interfere with the reaction. Aromatic hydrocarbons such as toluene are particularly suitable, since they readily form azeotropes with water, and the resulting water of reaction can thus be easily removed from the reaction vessel. Moreover, the reactions can be carried out in the presence of conventional catalysts such as p-toluenesulfonic acid, sulfuric acid, trifluoromethanesulfonic acid and titanic acid esters. As a rule, these reaction products used without purification.

The resulting hydroxyl-functional amide can be reacted with oxiranes or cyclic esters (lactones) with ring opening and consequent formation of new hydroxyl functions and can thus be adapted, in appropriate cases, to the needs of the situation, for example to polar systems such as water-containing systems, by addition of one or more ethylene oxide units to the hydroxyl groups. Examples of such oxiranes are ethylene oxide, propylene oxide, their mixtures and 2,3-epoxy-1-propanol. Examples of such lactones are β-propiolactone, δ-valerolactone, ε-caprolactone or substituted derivatives thereof. The resulting compounds are those of formula I in which y in (Q)_{y} is 1. Preferably, Q is an aliphatic hydrocarbon radical having 2 to 80 carbon atoms, which is linked via an ether or ester group to Z or Z′ and is interrupted by zero to 39 oxygen atoms and/or ester groups. Reaction with ethylene oxide or propylene oxide can be reacted by known processes under pressure, optionally with the use of the conventional catalysts such as, for example, alkali metal hydroxide, alkali metal alkoxide or boron trifluoride etherate, for example at temperatures from 130° C. to 200° C., to give the corresponding alkoxylates. These processes are described in: Nikolaus Schoenfeld, Grenzflaechenaktive Aethylenoxidaddukte, [Surface-active Ethylene Oxide Adducts], Wissenschaftliche Verlagsgesellschaft GmbH, Stuttgart (1976). Glycidol (2,3-epoxy-1-propanol) can be reacted with the polycarboxylic acid alkanolamides or polyamidopolycarboxylic acid alkanolamides according to the invention to give the corresponding glycerol ethers or polyglycerol ethers by following conventional procedures for the reaction involving ring opening with alcohols. These processes are described, for example, by: J. Biggs, N. B. Chapman and V. Wray in J. Chem. Soc. (B) 1971, 66. The reaction of the polycarboxylic acid alkanolamides or polyamidopolycarboxylic acid alkanolamides with lactones to form esters is carried out analogously to the processes described in U.S. Pat. No. 4,360,643. The reaction of the lactone takes place with the OH groups of the polycarboxylic acid alkanolamide or polyamidocarboxylic acid alkanolamide with ring opening and ester formation, for example at 100° C. to 180° C., either in suitable solvents such as high-boiling naphtha fractions, alkylbenzenes, esters or ketones, or directly in the melt, and it is catalyzed by, for example, p-toluenesulfonic acid or dibutyltin dilaurate.

In various embodiments, the curable coating composition includes from about 1% to about 100% by weight of the hydroxy-functional amide compound based on weight of fumed silica. Among these are embodiments in which the curable coating composition includes from about 5% to about 60% by weight of the hydroxy-functional amide compound based on weight of filmed silica.

The Volatile Organic Portion

The coating composition also includes a volatile organic portion, wherein the volatile organic portion comprises about 1 to about 7% by weight of a first volatile organic liquid or combination of first volatile organic liquids (i) having an evaporation rate less than 0.1 and (ii) in which a 10% by weight of a solution of the hydroxy-functional amide compound of formula I (50% by weight in xylene/alkylbenzenes/isobutanol in a 5/4/1 weight ratio) is insoluble. Nonlimiting examples of suitable first organic liquids are dipropylene glycol monomethyl ether acetate, diethylene glycol monobutyl ether acetate (also known as butyl carbitol acetate), oxo-decyl acetate, dipropylene glycol monomethyl ether acetate, oxo-octyl acetate, ethylene glycol mnobutyl ether acetate, Aromatic 150, odorless mineral spirits, mixtures of isoparaffins, any combinations of these. In various embodiments, the volatile organic portion of the coating composition includes from about 2-6% or about 2-5% or about 2-5% or about 3-5% by weight of the first volatile organic liquid or combination of first volatile organic liquids. It is preferred for the volatile organic portion to contain no volatile organic liquids with an evaporation rate less than 0.1 in which the hydroxy-functional amide compound is soluble; however, in some cases, a minor amount of such a volatile liquid relative to the first volatile liquid or liquids might be included, depending upon the particular circumstances.

In various embodiments the volatile organic portion also comprises at least about 10% by weight of a second volatile organic liquid or combination of second organic liquids having an evaporation rate greater than or equal to about 2.0. Nonlimiting examples of suitable second organic liquids are acetone, methyl ethyl ketone, diethyl ketone, methyl isopropyl ketone, methyl n-propyl ketone, methyl acetate, ethyl acetate, isopropyl acetate, propyl acetate, n-hexane, toluene tetrahydrofuran, methanol, and any combination of these. In certain of these embodiments, the volatile organic portion comprises at least about 12% by weight, or at least about 14% by weight, or at least about 16% by weight of the second volatile organic liquid or liquids. In various embodiments, the volatile organic portion may have up to about 30% by weight, or up to about 28% by weight, or up to about 25% by weight, or up to about 22% by weight, or up to about 20% by weight of the second volatile organic liquid or liquids.

The volatile organic portion of the coating composition includes other volatile organic liquids. Examples of useful solvents include, without limitation, methyl isobutyl ketone, methyl isoamyl ketone, methyl amyl ketone, diisobutyl ketone, n-butyl acetate, isobutyl acetate, m-amyl acetate, isobutyl isobutyrate, ethylene glycol butyl ether acetate, propylene glycol monomethyl ether acetate, n-butanol, isobutanol, 2-ethylhexanol, cyclohexanol, toluene, xylene, mineral spirits, blends of aromatic hydrocarbons such as those known as Aromatic 100 and Aromatic 150, and any combination of these.

Dispersant for the Fumed Silica

In various embodiments, the curable coating composition further includes 5 to 60% by weight of a dispersant for the fumed silica based on weight of fumed silica. Suitable pigment dispersions are known in the art and are readily available commercially. Nonlimiting examples of suitable pigment dispersants for the fumed silica include polyesters and pigment dispersants containing polyester segments, such as (but not limited to) dispersants having a number average molecular weight of from about 1000 to about 10,000 and dispersants having polyester segments resulting from polymerization of lactones (suitable examples of lactones being those already mentioned in connection with the hydroxy-functional amide compound, which may be reacted with monoalcohols such as 2-ethylhexanol, n-decanol, or a monohydroxy-functional polyether); pigment dispersants based on diisocyanates or polyisocyanates such as isocyanurates, providing a plurality of urethane linkages in the dispersant for the fumed silica, including those described by Haubennestel et al. in U.S. Pat. No. 4,942,213, incorporated herein by reference, especially those in which a diisocyanate or polyisocyanates with reacted with a hydroxy-functional polyester segment; low molecular weight polyacrylates; dispersants such as any of these having tertiary amine or amide groups; and so on. Suitable commercial pigment dispersants for the fumed silica include DISPERBYK-161, available from BYK-Chemie GMBH; Other Coating Composition Components

The coating composition comprises a binder, the binder for example comprising a crosslinker and a curable polymer reactive with the crosslinker. Nonlimiting examples of curable polymers include vinyl polymers such as acrylic polymers and modified acrylic polymers, polyesters, polyurethanes, epoxy resins, polycarbonates, polyamides, polyimides, polysiloxanes, and mixtures thereof, all of which are known in the art. The curable polymer has groups reactive with the crosslinker, such as, without limitation, hydroxyl groups, carbamate groups, terminal urea groups, carboxyl groups, epoxide groups, amino groups, thiol groups, hydrazide groups, activated methylene groups, and any combinations thereof that may be made in a thermosettable polymer.

In one preferred embodiment of the invention, the polymer is an acrylic polymer. The acrylic polymer preferably has a molecular weight of 500 to 1,000,000, and more preferably of 1500 to 50,000. As used herein, “molecular weight” refers to number average molecular weight, which may be determined by the GPC method using a polystyrene standard. Such polymers are well-known in the art, and can be prepared from monomers such as methyl acrylate, acrylic acid, methacrylic acid, methyl methacrylate, butyl methacrylate, cyclohexyl methacrylate, and the like. The active hydrogen functional group, e.g., hydroxyl, can be incorporated into the ester portion of the acrylic monomer. For example, hydroxy-functional acrylic monomers that can be used to form such polymers include hydroxyethyl acrylate, hydroxybutyl acrylate, hydroxybutyl methacrylate, hydroxypropyl acrylate, and the like. Amino-functional acrylic monomers would include t-butylaminoethyl methacrylate and t-butylamino-ethylacrylate. Other acrylic monomers having active hydrogen functional groups in the ester portion of the monomer are also within the skill of the art.

Modified acrylics can also be used as the film-forming curable polymer in the coating compositions. Such acrylics may be polyester-modified acrylics or polyurethane-modified acrylics, as is well known in the art. Polyester-modified acrylics modified with e-caprolactone are described in U.S. Pat. No. 4,546,046 of Etzell et al, the disclosure of which is incorporated herein by reference. Polyurethane-modified acrylics are also well known in the art. They are described, for example, in U.S. Pat. No. 4,584,354, the disclosure of which is incorporated herein by reference.

Polyesters having active hydrogen groups such as hydroxyl groups can also be used as the polymer in the coating composition. Such polyesters are well known in the art, and may be prepared by the polyesterification of organic polycarboxylic acids (e.g., phthalic acid, hexahydrophthalic acid, adipic acid, maleic acid) or their anhydrides with organic polyols containing primary or secondary hydroxyl groups (e.g., ethylene glycol, butylene glycol, neopentyl glycol).

Polyurethanes having active hydrogen functional groups are also well known in the art. They are prepared by a chain extension reaction of a polyisocyanate (e.g., hexamethylene diisocyanate, isophorone diisocyanate, MDI, etc.) and a polyol (e.g., 1,6-hexanediol, 1,4-butanediol, neopentyl glycol, trimethylol propane). They can be provided with active hydrogen functional groups by capping the polyurethane chain with an excess of diol, polyamine, amino alcohol, or the like.

Carbamate functional polymers and oligomers can also be used as curable polymer, especially those having at least one primary carbamate groups.

Carbamate functional examples of the curable polymer used in the coating compositions can be prepared in a variety of ways. One way to prepare such polymers is to prepare an acrylic monomer having carbamate functionality in the ester portion of the monomer. Such monomers are well known in the art and are described, for example in U.S. Pat Nos. 3,479,328, 3,674,838, 4,126,747, 4,279,833, and 4,340,497, 5,356,669, and WO 94/10211, the disclosures of which are incorporated herein by reference. One method of synthesis involves reaction of a hydroxy ester with urea to form the carbamyloxy carboxylate (i.e., carbamate-modified acrylic). Another method of synthesis reacts an α,β-unsaturated acid ester with a hydroxy carbamate ester to form the carbamyloxy carboxylate. Yet another technique involves formation of a hydroxyalkyl carbamate by reacting a primary or secondary amine or diamine with a cyclic carbonate such as ethylene carbonate. The hydroxyl group on the hydroxyalkyl carbamate is then esterified by reaction with acrylic or methacrylic acid to form the monomer. Other methods of preparing carbamate-modified acrylic monomers are described in the art, and can be utilized as well. The acrylic monomer can then be polymerized along with other ethylenically unsaturated monomers, if desired, by techniques well known in the art.

An alternative route for preparing the curable polymer of the binder is to react an already-formed polymer such as an acrylic polymer or polyurethane polymer with another component to form a carbamate-functional group appended to the polymer backbone, as described in U.S. Pat. No. 4,758,632. One technique for preparing such polymers involves thermally decomposing urea (to give off ammonia and HNCO) in the presence of a hydroxy-functional acrylic polymer to form a carbamate-functional polymer. Another technique involves reacting the hydroxyl group of a hydroxyalkyl carbamate with the isocyanate group of an isocyanate-functional polymer to form the carbamate-functional polymer. Isocyanate-functional acrylics are known in the art and are described, for example in U.S. Pat. No. 4,301,257, the disclosure of which is incorporated herein by reference. Isocyanate vinyl monomers are well known in the art and include unsaturated m-tetramethyl xylene isocyanate (sold by American Cyanamid as TMI®). Isocyanate-functional polyurethanes may be formed by using an equivalent excess of diisocyanate or by end-capping a hydroxyl-functional prepolymer with a polyisocyanate. Yet another technique is to react the cyclic carbonate group on a cyclic carbonate-functional acrylic with ammonia in order to form the carbamate-functional acrylic. Cyclic carbonate-functional acrylic polymers are known in the art and are described, for example, in U.S. Pat. No. 2,979,514, the disclosure of which is incorporated herein by reference. Another technique is to transcarbamylate a hydroxy-functional polymer with an alkyl carbamate. A more difficult, but feasible way of preparing the polymer would be to trans-esterify with a hydroxyalkyl carbamate.

The carbamate content of the polymer, on a weight per equivalent of carbamate functionality, will generally be between 200 and 1500, and preferably between 300 and 500.

The binder of the coating compositions further comprise a crosslinker. Crosslinkers may be used in amounts of from 1 to 90%, preferably from 3 to 75%, and more preferably from 25 to 50%, all based on the total binder of the coating composition.

The functional groups of the crosslinker are reactive with the functional groups of the polymer. Preferably, the reaction between the crosslinker and polymer form irreversible linkages. Examples of functional group “pairs” producing thermally irreversible linkages are hydroxy/isocyanate (blocked or unblocked), hydroxy/epoxy, carbamate/aminoplast, carbamate/aldehyde, acid/epoxy, amine/cyclic carbonate, amine/isocyanate (blocked or unblocked), urea/aminoplast, and the like.

Illustrative polymer functional groups include carboxyl, hydroxyl, aminoplast functional groups, urea, carbamate, isocyanate, (blocked or unblocked), epoxy, cyclic carbonate, amine, aldehyde and mixtures thereof. In various embodiments the polymer functional groups are hydroxyl, primary carbamate, isocyanate, aminoplast functional groups, epoxy, carboxyl and mixtures thereof. In certain embodiments the polymer functional groups are hydroxyl, primary carbamate, and mixtures thereof. It will be appreciated by those of skill in the art that it is the selection of a corresponding reactive functional groups in either the polymer or crosslinker that determine whether resulting linkages will be thermally reversible or irreversible.

The coating composition in certain embodiments includes an aminoplast as a crosslinker. An aminoplast for purposes of the invention is a material obtained by reaction of an activated nitrogen with a lower molecular weight aldehyde, optionally further reacted with an alcohol (preferably a mono-alcohol with one to four carbon atoms) to form an ether group. Preferred examples of activated nitrogens are activated amines such as melamine, benzoguanamine, cyclohexylcarboguanamine, and acetoguanamine; ureas, including urea itself, thiourea, ethyleneurea, dihydroxyethyleneurea, and guanylurea; glycoluril; amides, such as dicyandiamide; and carbamate functional compounds having at least one primary carbamate group or at least two secondary carbamate groups.

The activated nitrogen is reacted with a lower molecular weight aldehyde. The aldehyde may be selected from formaldehyde, acetaldehyde, crotonaldehyde, benzaldehyde, or other aldehydes used in making aminoplast resins, although formaldehyde and acetaldehyde, especially formaldehyde, are preferred. The activated nitrogen groups are at least partially alkylolated with the aldehyde, and may be fully alkylolated; preferably the activated nitrogen groups are fully alkylolated. The reaction may be catalyzed by an acid, e.g. as taught in U.S. Pat. No. 3,082,180, the contents of which are incorporated herein by reference.

The alkylol groups formed by the reaction of the activated nitrogen with aldehyde may be partially or fully etherified with one or more monofunctional alcohols. Suitable examples of the monofunctional alcohols include, without limitation, methanol, ethanol, propanol, isopropanol, butanol, isobutanol, tert-butyl alcohol, benzyl alcohol, and so on. Monofunctional alcohols having one to four carbon atoms and mixtures of these are preferred The etherification may be carried out, for example, by the processes disclosed in U.S. Pat. Nos. 4,105,708 and 4,293,692, the disclosures of which are incorporated herein by reference.

The aminoplast may be at least partially etherified, and in various embodiments the aminoplast is fully etherified. For example, the aminoplast compounds may have a plurality of methylol and/or etherified methylol, butylol, or alkylol groups, which may be present in any combination and along with unsubstituted nitrogen hydrogens. One nonlimiting examples of fully etherified melamine-formaldehyde resins is hexamethoxymethyl melamine. Aminoplast crosslinkers react with carbamate, terminal urea, and hydroxyl containing polymers.

The curable coating composition in certain embodiments includes a polyisocyanate or blocked polyisocyanate crosslinker. Useful polyisocyanate crosslinkers include, without limitation, isocyanurates, biurets, allophanates, uretdione compounds, and isocyanate-functional prepolymers such as the reaction product of one mole of a triol with three moles of a diisocyanate. The polyisocyanate may be blocked with lower alcohols, oximes, or other such materials that volatilize at curing temperature to regenerate the isocyanate groups.

An isocyanate or blocked isocyanate is may be used in 0.1-1.1 equivalent ratio, more preferably from 0.5-1.0 equivalent ratio to the amount of functional groups reactive therewith available from the crosslinkable materials.

For example, when the functional groups of either polymer or noncrystalline component are hydroxyl, functional groups of the crosslinker may be selected from the group consisting of isocyanate (blocked or unblocked), epoxy, and mixtures thereof, and most preferably will be isocyanate groups, whether blocked or unblocked.

Illustrative examples of epoxide-functional crosslinkers are all known epoxide-functional polymers and oligomers. Preferred epoxide-functional crosslinking agents are glycidyl methacrylate polymers and isocyanurate-containing, epoxide-functional materials such as trisglycidyl isocyanurate and the reaction product of glycidol with an isocyanate functional isocyanurate such as the trimer of isophorone diisocyanate (IPDI). Polyepoxide functional crosslinkers are suitable for use with carboxyl functional polymers.

The coating composition may include a catalyst to enhance the cure reaction. For example, especially when monomeric melamines are used as a curing agent, a strong acid catalyst may be utilized to enhance the cure reaction. Such catalysts are well-known in the art and include, without limitation, p-toluene sulfonic acid, dinonylnaphthalene disulfonic acid, dodecylbenzenesulfonic acid, phenyl acid phosphate, monobutyl maleate, butyl phosphate, and hydroxy phosphate ester. Strong acid catalysts are often blocked, e.g. with an amine. For the reaction of polyisocyanates with suitable functionalities, suitable catalysts include tin compounds such as dibutyl tin dilaurate, dibutyl tin diacetate, dibutyl tin oxide, tertiary amines, zinc salts, and manganese salts. Reactions between epoxide and carboxyl groups may be catalyzed with tertiary amines or quaternary ammonium salts (e.g., benzyldimethylamine, dimethylaminocyclohexane, triethylamine, N-methylimidazole, tetramethyl ammonium bromide, and tetrabutyl ammonium hydroxide.), tin and/or phosphorous complex salts (e.g., (CH₃)₃ SNI, (CH₃)₄ PI, triphenylphosphine, ethyltriphenyl phosphonium iodide, tetrabutyl phosphonium iodide) and so on.

Additional agents, for example hindered amine light stabilizers, ultraviolet light absorbers, anti-oxidants, surfactants, stabilizers, wetting agents, rheology control agents, dispersing agents, adhesion promoters, etc. may be incorporated into the coating composition. Such additives are well-known and may be included in amounts typically used for coating compositions.

In various embodiments, the coating composition is utilized as a clearcoat composition for preparing the clearcoat layer of a composite color-plus-clear coating. The pigmented basecoat composition over which it is applied may be any of a number of types well-known in the art, and does not require explanation in detail herein. Polymers known in the art to be useful in basecoat compositions include acrylics, vinyls, polyurethanes, polycarbonates, polyesters, alkyds, and polysiloxanes. Preferred polymers include acrylics and polyurethanes. Basecoat polymers may be thermoplastic, but are preferably crosslinkable and comprise one or more type of crosslinkable functional groups. Such groups include, for example, hydroxy, isocyanate, amine, epoxy, acrylate, vinyl, silane, and acetoacetate groups. These groups may be masked or blocked in such a way so that they are unblocked and available for the crosslinking reaction under the desired curing conditions, generally elevated temperatures. Preferred crosslinkable functional groups include hydroxy functional groups and amino functional groups.

In other embodiments, the coating composition is utilized as a basecoat composition for preparing the basecoat layer a composite color-plus-clear coating or as a pigmented topcoat composition for preparing monocoat topcoat layer. These coating compositions may include any pigment or combination of pigments useful for such coating compositions. One or more particulate fillers may also be included. Pigments and fillers may be utilized in amounts typically of up to about 40% by weight, based on total weight of the coating composition. The pigments used may be inorganic pigments, including metal oxides, chromates, molybdates, phosphates, and silicates. Examples of inorganic pigments and fillers that could be employed are titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium ferrocyanide (Prussian blue), ultramarine, lead chromate, lead molybdate, and mica flake pigments. Organic pigments may also be used. Examples of useful organic pigments are metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, and the like. The pigment or pigments are preferably dispersed in a resin or polymer or with a pigment dispersant, such as already described in combination with the fumed silica, according to known methods. In general, the pigment and dispersing resin, polymer, or dispersant are brought into contact under a shear high enough to break the pigment agglomerates down to the primary pigment particles and to wet the surface of the pigment particles with the dispersing resin, polymer, or dispersant. The breaking of the agglomerates and wetting of the primary pigment particles are important for pigment stability and color development.

The fumed silica-hydroxy amide compound-first volatile organic liquid combination of the present coating compositions is particularly useful in conjunction with special effect flake pigments (e.g., metallic and pearlescent pigments). Metallic topcoat colors are produced using one or more special flake pigments. Metallic colors are generally defined as colors having gonioapparent effects. For example, the American Society of Testing Methods (ASTM) document F284 defines metallic as “pertaining to the appearance of a gonioapparent material containing metal flake.” Metallic basecoat colors may be produced using metallic flake pigments like aluminum flake pigments, copper flake pigments, zinc flake pigments, stainless steel flake pigments, and bronze flake pigments and/or using pearlescent flake pigments including treated micas like titanium dioxide-coated mica pigments and iron oxide-coated mica pigments to give the coatings a different appearance when viewed at different angles. Unlike the solid color pigments, the flake pigments do not agglomerate and are not ground under high shear because high shear would break or bend the flakes or their crystalline morphology, diminishing or destroying the gonioapparent effects. The flake pigments are satisfactorily dispersed in a binder component by stirring under low shear.

The coating compositions may also be prepared to be suitable as primer coating compositions for producing primer coating layers. In general, such primers may include a curable binder such as already mentioned with, for example, a polyester, polyurethane, alkyd, epoxy, or vinyl resin (e.g., acrylic resin) and an aminoplast, polycarboxylic acid, or polyisocyanate crosslinker, one or more pigments and/or fillers, and conventional coating additives such as catalysts, wetting agents, and so on.

In general, a substrate may be coated by applying a primer layer, optionally curing the primer layer; then applying a basecoat layer and a clearcoat layer, typically wet-on-wet, and curing the applied layers and optionally curing the primer layer along with the basecoat and clearcoat layers if the primer layer is not already cured, or then applying a monocoat topcoat layer and curing the monocoat topcoat layer, again optionally curing the primer layer along with the basecoat and clearcoat layers if the primer layer is not already cured. The cure temperature and time may vary depending upon the particular binder components selected, but typical industrial and automotive thermoset compositions prepared as we have described may be cured at a temperature of from about 105° C. to about 175° C., and the length of cure is usually about 15 minutes to about 60 minutes.

The coating composition can be coated on a substrate by spray coating. Electrostatic spraying is a preferred method. The coating composition can be applied in one or more passes to provide a film thickness after cure of a desired thickness, typically from about 10 to about 40 microns for primer and basecoat layers and from about 20 to about 100 microns for clearcoat and monocoat topcoat layers.

The coating composition can be applied onto many different types of substrates, including metal substrates such as bare steel, phosphated steel, galvanized steel, or aluminum; and non-metallic substrates, such as plastics and composites. The substrate may also be any of these materials having upon it already a layer of another coating, such as a layer of an electrodeposited primer, primer surfacer, and/or basecoat, cured or uncured.

The substrate may be first primed with an electrodeposition (electrocoat) primer. The electrodeposition composition can be any electrodeposition composition used in automotive vehicle coating operations. Non-limiting examples of electrocoat compositions include the CATHOGUARD® electrocoating compositions sold by BASF Corporation, such as CATHOGUARD® 500. Electrodeposition coating baths usually comprise an aqueous dispersion or emulsion including a principal film-forming epoxy resin having ionic stabilization (e.g., salted amine groups) in water or a mixture of water and organic cosolvent. Emulsified with the principal film-forming resin is a crosslinking agent that can react with functional groups on the principal resin under appropriate conditions, such as with the application of heat, and so cure the coating. Suitable examples of crosslinking agents, include, without limitation, blocked polyisocyanates. The electrodeposition coating compositions usually include one or more pigments, catalysts, plasticizers, coalescing aids, antifoaming aids, flow control agents, wetting agents, surfactants, UV absorbers, HALS compounds, antioxidants, and other additives.

The electrodeposition coating composition is preferably applied to a dry film thickness of 10 to 35 μm. After application, the coated vehicle body is removed from the bath and rinsed with deionized water. The coating may be cured under appropriate conditions, for example by baking at from about 275° F. to about 375° F. (about 135° C. to about 190° C.) for between about 15 and about 60 minutes.

The invention is further described in the following example. The example is merely illustrative and does not in any way limit the scope of the invention as described and claimed. All parts are parts by weight unless otherwise noted.

### EXAMPLES

In Examples 1 to 4, coating compositions prepared with the components shown in the following table are prepared and sprayed as clearcoat layers over previously applied black basecoats, wet-on-wet, in a wedge of increasing filmbuild. The applied clearcoats are then cured and the filmbuild, in microns, at which a ¼ inch sag developed in the clearcoat layer is recorded in the following table. These examples demonstrate sag resistance attained with two levels of the hydroxy-functional amide compound (Byk 405 available from BYK Chemie) for two levels of a first volatile organic compound, which in these examples is dipropylene glycol monomethyl ether acetate (DPMA), and show that, for a given amount of Byk 405, sag resistance increases with increasing amount of the first volatile organic compound. All other components used in making the clearcoats were held the same (given the adjustments needed to change levels of Byk-405 and DPMA).

| | EXAMPLE | | | |
|---|---|---|---|---|
| | 1 | 2 | 3 | 4 |
| Crosslinkable Resin, % by weight of | 54 | 54 | 54 | 54 |
| binder (fixed vehicle) | | | | |
| Crosslinker Resin, % by weigh of binder | 36 | 36 | 36 | 36 |
| (fixed vehicle) | | | | |
| DPMA, % by weight of volatile organic | 2 | 2 | 4 | 4 |
| portion | | | | |
| Methyl Propyl Ketone, % by weight of | 17 | 17 | 17 | 17 |
| volatile organic portion | | | | |
| fumed silica, % by weight on binder (fixed | 1.1 | 1.1 | 1.1 | 1.1 |
| vehicle) | | | | |
| Byk-405, % by weight on silica | 9.2 | 18.5 | 9.2 | 18.5 |
| film build in microns, @ ¼ inch sag | 58 | 61 | 62 | 67 |

In Examples 5 and 6 shown in the next table, the effect of adding a pigment dispersant, Dysperbyk 161, for the fumed silica is illustrated. Again, coating compositions prepared with the components shown in the following table are prepared and sprayed as clearcoat layers over previously applied black basecoats, wet-on-wet, in a wedge of increasing filmbuild. The applied clearcoats are then cured and the filmbuild, in microns, at which a ¼ inch and a 4 mm sag developed in the clearcoat layer is recorded in the following table. The orange peel (OP) was measure using a Byk Wavescan Dual. Unexpectedly, while the Dysperbyk reduced orange peel, it did not cause increased sagging.

| | EXAMPLE | |
|---|---|---|
| | 5 | 6 |
| Crosslinkable Resin, % by weight of binder (fixed vehicle). | 57 | 57 |
| Crosslinker Resin, % by weight of binder (fixed vehicle). | 36 | 36 |
| DPMA, % by weight of volatile organic portion | 4 | 4 |
| Methyl Propyl Ketone, % by weight of volatile | 22 | 22 |
| organic portion | | |
| fumed silica, % by weight on binder (fixed vehicle) | 0.25 | 0.25 |
| Byk-405, % on silica | 40 | 40 |
| Disperbyk 161, % on silica | 0 | 50 |
| film build in microns, @ ¼ inch sag | 56 | 57 |
| film build in microns, @ 4 mm sag | 49 | 49 |
| Leveling: clearcoat film build in microns @ OP = 35 | 21 | 17 |
| Leveling: OP value at CC film build = 30 microns | 59 | 67 |

The invention has been described in detail with reference to preferred embodiments thereof. It should be understood, however, that variations and modifications can be made within the spirit and scope of the invention and of the following claims.

What is claimed is:

1. A curable coating composition comprising
(a) fumed silica;
(b) a hydroxy-functional amide compound of formula I 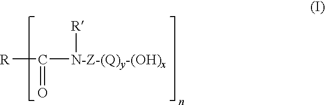
wherein R is selected from aliphatic hydrocarbon groups having 2 to 60 carbon atoms, aromatic hydrocarbon groups having 6 to 20 carbon atoms, and aliphatic and aliphatic/aromatic radicals having 6 to 150 carbon atom interrupted by up to 8 amide groups, ester groups, a combination of amide and ester groups, or optionally any of these and also with interrupting amine groups, and aliphatic radicals having 4 to 150 carbon atoms interrupted by 2 to 75 oxygen atoms or ester groups; R′ is H, an alkyl group with one to four carbon atoms, or -Z′-(Q)_{y}-(OH)ₓ; x is 1, 2, or 3; y is 0 or 1; Z and Z′ are independently alkylene radicals having 2 to 6 carbon atoms; Q is an aliphatic hydrocarbon radical having 2 to 200 carbon atoms that is linked to Z or Z′ by an ether or carboxylic acid ester group and is interrupted by 0 to 99 oxygen atoms and/or carboxylic acid ester groups; and n is 2 or 3; and
(c) a volatile organic portion, wherein the volatile organic portion comprises about 1 to about 7% by weight of a first volatile organic liquid or combination of first volatile organic liquids (i) having an evaporation rate less than or equal to 0.1 and (ii) in which the hydroxy-functional amide compound is insoluble.

2. A curable coating composition according to claim 1, wherein the volatile organic portion further comprises at least about 10% by weight of a second volatile organic liquid having an evaporation rate greater than or equal to about 2.0, or a combination of such second volatile organic liquids.

3. A curable coating composition according to claim 1, comprising from about 1% to about 100% by weight of the hydroxy-functional amide compound based on weight of fumed silica.

4. A curable coating composition according to claim 1, comprising from about 5% to about 60% by weight of the hydroxy-functional amide compound based on weight of fumed silica.

5. A curable coating composition according to claim 1, comprising from about 5% to about 60% by weight of a dispersant for the fumed silica based on weight of filmed silica, wherein the dispersant is soluble in the first volatile organic liquid or liquids.

6. A curable coating composition according to claim 1, comprising from about 0.1 to about 5 percent by weight fumed silica based on binder.

7. A curable coating composition according to claim 1, wherein R is or includes the hydrocarbon group of dodecanedioic acid or of a dimer fatty acid.

8. A curable coating composition according to claim 1, wherein R comprises up to 8 amide groups, ester groups, a combination of amide and ester groups.

9. A curable coating composition according to claim 1, wherein R comprises an amine group.

10. A curable coating composition according to claim 1, wherein the volatile organic portion comprises from about 2% to about 5% by weight of the first volatile organic liquid or liquids.

11. A curable coating composition according to claim 1, comprising the first volatile organic liquid is selected from the group consisting of dipropylene glycol monomethyl ether acetate, diethylene glycol monobutyl ether acetate (also known as butyl carbitol acetate), oxo-decyl acetate, dipropylene glycol monomethyl ether acetate, oxo-octyl acetate, ethylene glycol mnobutyl ether acetate, Aromatic 150, odorless mineral spirits, mixtures of isoparaffins, and combinations thereof.

12. A curable coating composition according to claim 2, wherein the second volatile organic liquid is selected from the group consisting of acetone, methyl ethyl ketone, diethyl ketone, methyl isopropyl ketone, methyl n-propyl ketone, methyl acetate, ethyl acetate, isopropyl acetate, propyl acetate, n-hexane, toluene tetrahydrofuran, methanol, and combinations thereof.

13. A curable coating composition according to claim 5, wherein the dispersant for the fumed silica comprises a polyester segment.

14. A curable coating composition according to claim 5, wherein the dispersant for the fumed silica comprises a polylactone segment.

15. A curable coating composition according to claim 5, wherein the dispersant for the fumed silica comprises a plurality of urethane linkages.

16. A curable coating composition according to claim 1, wherein the curable coating composition is a clearcoat composition, a basecoat composition, or a monocoat topcoat composition.

17. A method of coating a substrate, comprising applying a layer of the curable coating composition according to claim 1 and curing the applied layer.

18. A method of coating a substrate, comprising applying a layer of the curable coating composition according to claim 2 and curing the applied layer.

19. A method of coating a substrate, comprising applying a layer of the curable coating composition according to claim 5 and curing the applied layer.
